(19) United States
(12) Patent Application Publication
(10) Pub. No.: US 2009/0241102 A1
(43) Pub. Date: Sep. 24, 2009

(54) METHOD FOR UPDATING ELECTRONIC DICTIONARY

(75) Inventor: Shaw-Fuu Wang, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/052,378

(22) Filed: Mar. 20, 2008

(51) Int. Cl. G06F 9/44

(52) U.S. Cl. 717/171

(57) ABSTRACT

A method for updating an electronic dictionary is provided. The method is adapted to an electronic dictionary software and the electronic dictionary software is respectively installed into a plurality of personal computers. Each personal computer is connected to an integrated platform through an intranet and the integrated platform possesses an electronic dictionary database. The method includes inputting at lease one update datum through a user interface of the electronic dictionary software on at least one of the personal computers. Then, the integrated platform receives the update datum through the intranet. Thereafter, the update datum is identified. Finally, the update datum is stored into the electronic dictionary database.

### BACKGROUND OF THE INVENTION

1. Field of the Invention

The present invention generally relates to a method for using an integrated system, in particular, to a method for updating an electronic dictionary.

2. Description of Related Art

As the rapid progress of software development, more and more novel application software appears. Through software development, the commonly used reference books such as dictionaries, has also changed from the form of papers into electronic dictionaries (electronic translation dictionaries) installed into a personal computer. However, similar to the dictionaries in the form of papers, the electronic dictionaries have also classified into different word stocks depending upon different using requirements, for example, the commonly-used English to Chinese translation word stock, English to English definition word stock, other foreign language translation word stocks, or even professional medical dictionary, engineering dictionary, and the like.

In addition, different users with different backgrounds may have their own commonly used idiomatic words, proper nouns, special abbreviations and acronyms, based upon different technical fields, all these special words and meanings cannot be supported by a built-in word stock in a common commercially available electronic dictionary. If the user encounters a word and a meaning in a professional field when using an electronic dictionary, and the prevailing built-in word stock of the electronic dictionary cannot query such a professional meaning or idiom, he/she has to search relevant terms over Internet or even turns back to the professional paper dictionaries to find the answer.

Furthermore, the user may add some new professional glossaries in the built-in word stock of the electronic dictionary in the personal computer, which not only increases the burden for the storage medium of the personal computer, but those group members sharing this electronic dictionary, for example, staff of the same company, or colleagues in the same working team also cannot access each other's word stock, and as a result, their respective proper nouns or special abbreviations are inconsistent with each other, and even reducing the users' working efficiency.

### SUMMARY OF THE INVENTION

Accordingly, the present invention is directed to a method for updating an electronic dictionary, which enables group members sharing one electronic dictionary to create an exclusive professional special word stock.

The present invention is further directed to a method for updating an electronic dictionary, which enables group members sharing one electronic dictionary to add new glossary and definition, and to expand the shared professional word stock on line in real time, so as to enhance the users' working efficiency.

The present invention provides a method for updating an electronic dictionary, which is adapted to an electronic dictionary software. The electronic dictionary software is respectively installed into a plurality of personal computers connected to an integrated platform through an intranet, in which the integrated platform possesses an electronic dictionary database. The method includes inputting at least one update datum through a user interface of the electronic dictionary software on at least one of the personal computers; the integrated platform receiving the update datum through the intranet; identifying the update datum; and finally, storing the update datum into the electronic dictionary database.

In the method for updating the electronic dictionary according to an embodiment of the present invention, a data content of the update datum includes a new glossary, a new glossary definition, a glossary explanation request, a glossary meaning supplement, and a glossary meaning amendment.

In the method for updating the electronic dictionary according to an embodiment of the present invention, the step of identifying the update datum includes determining a single character target of the update datum. In addition, the step of storing the update datum includes storing the update datum into a glossary data sheet corresponding to the single character target in the electronic dictionary database according to the single character target. Furthermore, the step of storing the update datum into the electronic dictionary database further includes creating a new glossary data sheet according to the single character target if the electronic dictionary database does not possess the glossary data sheet corresponding to the single character target. Furthermore, the step of storing the update datum includes storing the update datum into a data table corresponding to the single character target in the electronic dictionary database according to the single character target. Furthermore, the step of storing the update datum into the electronic dictionary database further includes creating a new data table according to the single character target, if the electronic dictionary database does not possess the data table corresponding to the single character target.

The method for updating the electronic dictionary according to an embodiment of the present invention further includes the integrated platform broadcasting an update message to each of the personal computers through the intranet; and then, each of the personal computers updating a built-in word stock of the electronic dictionary installed in each of the personal computers according to the update message. Furthermore, the update message includes a new glossary code.

The method for updating the electronic dictionary according to an embodiment of the present invention further includes the integrated platform broadcasting an update message to each of the personal computers through the intranet; next, connecting at least one of the personal computers into the integrated platform through the intranet; then, sending a glossary query request to the integrated platform through the user interface; then, the integrated platform searching a glossary data sheet corresponding to the glossary query request in the electronic dictionary database according to the glossary query request; afterwards, returning a query result to the personal computer, in which the query result includes a data content of the glossary data sheet; and finally, displaying the data content on the personal computer through the user interface.

In the method for updating the electronic dictionary according to an embodiment of the present invention, in which the integrated platform includes a server.

The present invention further provides a method for using an electronic dictionary, which is adapted to an electronic dictionary software. The electronic dictionary software is respectively installed into a plurality of personal computers connected to an integrated platform through an intranet, in which the integrated platform possesses an electronic dictionary database. The method includes querying a glossary in a built-in word stock of the electronic dictionary software through a user interface of the electronic dictionary software on at least one of the personal computers. If the built-in word stock does not possess a corresponding glossary datum corresponding to the glossary, the method includes connecting the personal computer to the integrated platform through the intranet; then, inputting an update datum at least relevant to the glossary through a user interface of the electronic dictionary software; then, the integrated platform receiving the update datum through the intranet; then, identifying the update datum; afterwards, storing the update datum into the electronic dictionary database; then, the integrated platform broadcasting an update message to each of the personal computers through the intranet; and finally, each of the personal computers updating the built-in word stock of the electronic dictionary installed into each of the personal computers according to the update message.

In the method for using the electronic dictionary according to an embodiment of the present invention, a data content of the update datum includes a new glossary, a new glossary definition, a glossary explanation request, a glossary meaning supplement, and a glossary meaning amendment.

In the method for using the electronic dictionary according to an embodiment of the present invention, the step of identifying the update datum further includes determining a single character target of the update datum. The step of storing the update datum includes storing the update datum into a glossary data sheet corresponding to the single character target in the electronic dictionary database according to the single character target. Furthermore, the step of storing the update datum into the electronic dictionary database further includes creating a new glossary data sheet according to the single character target, if the electronic dictionary database does not possess the glossary data sheet corresponding to the single character target.

In the method for using the electronic dictionary according to an embodiment of the present invention, the update message includes a new glossary code.

In the method for using the electronic dictionary according to an embodiment of the present invention, the integrated platform includes a server.

The following problems often occur when using the electronic dictionary, for example, the built-in word stock of the electronic dictionary lacks of special glossaries or proper nouns, or the built-in word stock misplaces the meanings of the proper nouns or special glossaries or lacks of sufficient definitions. Under such circumstances, in the present invention, the user may offer some new glossaries, new definitions, or propose some explanation requests, as well as the glossary meaning supplements or glossary meaning amendments, and then, the glossary update data sent from the users are all collected and sorted by the integrated platform, and then the valid glossaries are used for updating the database of the integrated platform or they are stored into the database of the integrated platform. Therefore, an exclusive special word stock may be created among the same group of members of the electronic dictionary system and thus enhancing the group members' working efficiency.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a follow chart of processes of a method for updating an electronic dictionary according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

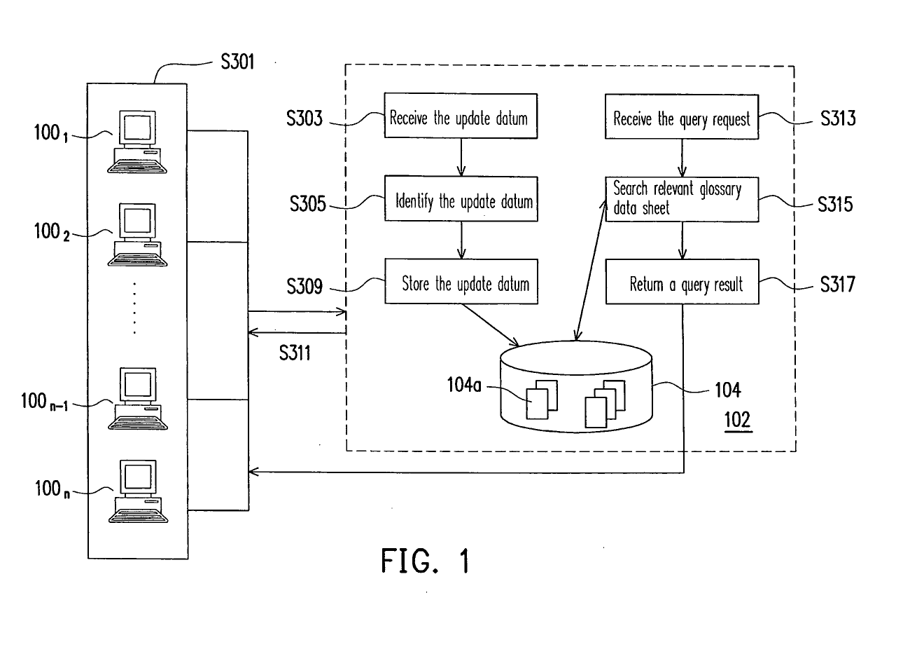

FIG. 1 is a follow chart of processes of a method for updating an electronic dictionary according to an embodiment of the present invention. Referring to FIG. 1, an electronic dictionary software is respectively installed into several personal computers 100₁ to 100ₙ respectively connected to an integrated platform 102 through an intranet. The integrated platform 102 possesses an electronic dictionary database 104 that contains several glossary data sheets 104a. Each glossary data sheet 104a stores a glossary and the corresponding definition, tense, or synonym and antonym relationship with other glossaries. In another embodiment, the electronic dictionary database 104 may have several data tables, and each data table stores a glossary and the corresponding definition, tense, or synonym and antonym relationship with other glossaries. The integrated platform 102 is, for example, a server.

First of all, in Step S301, at least one update datum is input through a user interface of the electronic dictionary software on at least one of the personal computers 100₁ to 100ₙ. A data content of the update datum includes, for example, a new glossary, a new glossary definition, a glossary explanation request, a glossary meaning supplement, and a glossary meaning amendment. That is to say, when the user queries a special glossary through using the electronic dictionary software at an personal computer, if it is found that the built-in word stock of the electronic dictionary software does not have the glossary datum corresponding to the above special glossary or the query result is not satisfactory, the user may input a new glossary or the new glossary definition, glossary explanation request for re-explaining the meaning, or glossary meaning supplement or amendment together with the glossary as an update datum through the user interface of the electronic dictionary software.

Then, in Step S303, the integrated platform 102 receives the update datum through the intranet. Then, in Step S305, the update datum is identified, so as to determine whether the received update datum is a valid datum or not, that is, to determine the content of the received update datum including the new glossary, new glossary definition, glossary meaning supplement, or glossary meaning amendment are correct or not. Furthermore, Step S305 of identifying the update datum further includes determining a single character target for the received update datum, i.e., determining a single character relevant to the received update datum.

Finally, according to the above single character target, the received update datum is stored into the electronic dictionary database 104, that is, the update datum is stored into the glossary data sheet 104a corresponding to the single character target of the update datum in the electronic dictionary database 104 of the integrated platform 102. Furthermore, if the electronic dictionary database 104 does not possess a glossary data sheet 104a corresponding to the single character target of the update datum, the step of storing the update datum into the electronic dictionary database 104 further includes creating a corresponding new glossary data sheet 104a according to the single character target. In another embodiment, the update datum is stored into fields of definition, tense, or synonym and antonym relationship with other glossaries and the like of a data table corresponding to the single character target of the update datum in the electronic dictionary database 104 of the integrated platform 102. Furthermore, if the electronic dictionary database 104 does not possess a data table corresponding to the single character target of the update datum, the step of storing the update datum into the electronic dictionary database 104 further includes creating a corresponding new data table according to the single character target.

In an embodiment, if the integrated platform 102 has finished the above step of storing the update datum, the method for updating the electronic dictionary of the present invention further includes: the integrated platform 102 broadcasting an update message to each of the personal computers through the intranet, and then, each of the personal computers updating the built-in word stock of the electronic dictionary installed therein according to the received update message (Step S311). The update message includes, for example, a new glossary code.

In another embodiment, after the integrated platform 102 finishes the above step of storing the update datum (S309), and the integrated platform 102 broadcasts an update message to each of the personal computers through the intranet (S311), the method for updating an electronic dictionary according to the present invention further includes connecting one of the personal computers 100₁ to 100ₙ to the integrated platform through the intranet; and then sending a glossary query request to the integrated platform 102 through the user interface. Referring to FIG. 1, in Step S313, the integrated platform 102 receives the glossary query request, and then, according to the glossary query request, the integrated platform 102 searches the glossary data sheet 104a/data table corresponding to the received glossary query request in the electronic dictionary database 104 (Step S315). Then, if the electronic dictionary database 104 possesses the glossary data sheet 104a/data table corresponding to the above glossary query request, in Step S317, a query result is returned to the personal computer, in which the query result includes a data content of the corresponding glossary data sheet 104a/data table. Finally, the data content is displayed on the personal computer through the user interface.

To sum up, the following problem often occur when using the electronic dictionary, for example, the built-in word stock of the electronic dictionary lacks of special glossaries or proper nouns, or the built-in word stock misplaces the meanings of the proper nouns or special glossaries or lacks of sufficient definitions, but in the present invention, the user may offer some new glossaries, new definitions or propose meaning explanation requests, as well as glossary meaning supplements or glossary meaning amendments, and then, the glossary update data sent from the users are all collected and sorted by the integrated platform, and then the valid glossaries are used for updating the database of the integrated platform or they are stored into the database of the integrated platform. Furthermore, the integrated platform periodically informs all the personal computers connected to the integrated platform, and updates the built-in word stock of the electronic dictionary. With the method for updating the electronic dictionary according to the present invention, a special word stock may be created under the same using environment, and the users sharing this special word stock may use the updated special word stock by directly connecting to the integrated platform through the intranet according to the update messages periodically send by the integrated platform. Therefore, users sharing this method for updating the electronic dictionary may work together to create an exclusive professional word stock, so as to eliminate the defect that the built-in word stock of the electronic dictionary lacks of glossaries in the professional fields and meanwhile enhance the users' working efficiency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for updating an electronic dictionary, adapted to an electronic dictionary software, wherein the electronic dictionary software is respectively installed into a plurality of personal computers connected to an integrated platform through an intranet, and the integrated platform possesses an electronic dictionary database, the method comprising:
inputting at least one update datum through a user interface of the electronic dictionary software on at least one of the personal computers;
the integrated platform receiving the update datum through the intranet;
identifying the update datum; and
storing the update datum into the electronic dictionary database.

2. The method for updating an electronic dictionary according to claim 1, wherein a data content of the update datum comprises a new glossary, a new glossary definition, a glossary explanation request, a glossary meaning supplement, and a glossary meaning amendment.

3. The method for updating an electronic dictionary according to claim 1, wherein the step of identifying the update datum further comprises determining a single character target of the update datum.

4. The method for updating an electronic dictionary according to claim 3, wherein the step of storing the update datum comprises:
storing the update datum into a glossary data sheet corresponding to the single character target in the electronic dictionary database according to the single character target.

5. The method for updating an electronic dictionary according to claim 4, wherein the step of storing the update datum into the electronic dictionary database further comprises creating a new glossary data sheet according to the single character target, if the electronic dictionary database does not possess the glossary data sheet corresponding to the single character target.

6. The method for updating an electronic dictionary according to claim 3, wherein the step of storing the update datum comprises:
storing the update datum into a data table corresponding to the single character target in the electronic dictionary database according to the single character target.

7. The method for updating an electronic dictionary according to claim 6, wherein the step of storing the update datum into the electronic dictionary database further comprises creating a new data table according to the single character target, if the electronic dictionary database does not possess the data table corresponding to the single character target.

8. The method for updating an electronic dictionary according to claim 1, further comprising:
the integrated platform broadcasting an update message to each of the personal computers through the intranet; and
each of the personal computers updating a built-in word stock of the electronic dictionary installed in each of the personal computers according to the update message.

9. The method for updating an electronic dictionary according to claim 8, wherein the update message comprises a new glossary code.

10. The method for updating an electronic dictionary according to claim 1, further comprising:
the integrated platform broadcasting an update message to each of the personal computers by through the intranet;
connecting at least one of the personal computers to the integrated platform through the intranet;
sending a glossary query request to the integrated platform through the user interface;
the integrated platform searching a glossary data sheet corresponding to the glossary query request in the electronic dictionary database according to the glossary query request;
returning a query result to the personal computer, wherein the query result comprises a data content of the glossary data sheet; and
displaying the data content on the personal computer through the user interface.

11. The method for updating an electronic dictionary according to claim 1, wherein the integrated platform comprises a server.

12. A method for using an electronic dictionary, adapted to an electronic dictionary software, wherein the electronic dictionary software is respectively installed into a plurality of personal computers connected to an integrated platform through an intranet, and the integrated platform possesses an electronic dictionary database, the method comprising:
querying a glossary from a built-in word stock of the electronic dictionary software through a user interface of the electronic dictionary software on at least one of the personal computers;
if the built-in word stock does not possess a glossary datum corresponding to the glossary:
connecting the personal computer to the integrated platform through the intranet;
inputting an update datum at least relevant to the glossary through a user interface of the electronic dictionary software;
the integrated platform receiving the update datum through the intranet;
identifying the update datum;
storing the update datum into the electronic dictionary database;
the integrated platform broadcasting an update message to each of the personal computers through the intranet; and
each of the personal computers updating the built-in word stock of the electronic dictionary installed in each of the personal computers according to the update message.

13. The method for using an electronic dictionary according to claim 12, wherein a data content of the update datum comprises a new glossary, a new glossary definition, a glossary explanation request, a glossary meaning supplement, and a glossary meaning amendment.

14. The method for using an electronic dictionary according to claim 12, wherein the step of identifying the update datum further comprises determining a single character target of the update datum.

15. The method for using an electronic dictionary according to claim 14, wherein the step of storing the update datum comprises:
storing the update datum into a glossary data sheet corresponding to the single character target in the electronic dictionary database according to the single character target.

16. The method for using an electronic dictionary according to claim 15, wherein the step of storing the update datum into the electronic dictionary database further comprises creating a new glossary data sheet according to the single character target, if the electronic dictionary database does not possess the glossary data sheet corresponding to the single character target.

17. The method for using an electronic dictionary according to claim 12, wherein the update message comprises a new glossary code.

18. The method for using an electronic dictionary according to claim 12, wherein the integrated platform comprises a server.
